(19) United States
(12) Patent Application Publication
(10) Pub. No.: US 2025/0375037 A1
(43) Pub. Date: Dec. 11, 2025

(54) Multipurpose Lounge Chair Device

(71) Applicant: Chasety Clemons, Alger, OH (US)

(72) Inventor: Chasety Clemons, Alger, OH (US)

(21) Appl. No.: 19/235,050

(22) Filed: Jun. 11, 2025

Related U.S. Application Data
(60) Provisional application No. 63/658,458, filed on Jun. 11, 2024.

(51) Int. Cl. A47C 1/14; A47C 4/00; A47C 4/42; A47C 7/54; A47C 7/62; A47C 7/66; A47C 7/68; A47C 7/72; A47C 7/74; A47C 31/00; H02J 7/00; H02J 7/35

(52) U.S. Cl. CPC A47C 1/14; A47C 4/00; A47C 7/54; A47C 7/624; A47C 7/664; A47C 7/68; A47C 7/727; A47C 7/744; A47C 31/008; H02J 7/0044; H02J 7/35; A47C 4/42

(57) ABSTRACT

A multipurpose lounge chair device is provided. The device is comprised of a foldable and reclining frame that supports a seating body fabricated from cooling bungee weave. The device comprises a shade canopy made from UV-reflective fabric, which is pivotally mounted to the frame via adjustable hinges or articulated brackets to maximize solar exposure and shade coverage. At least one flexible monocrystalline solar panel is embedded in the canopy and configured to charge an onboard lithium-based battery. The battery powers at least one fan and at least one Bluetooth speaker, both of which may be controlled by a wired or wireless remote. A swing-out charging station table is attached to the frame by a pivot mechanism and includes multiple charging ports, such as USB or wireless charging pads, along with a non-slip surface for item placement.

### CROSS-REFERENCE TO RELATED APPLICATION

The present application claims priority to, and the benefit of, U.S. Provisional Application No. 63/658,458, which was filed on Jun. 11, 2024, and is incorporated herein by reference in its entirety.

### FIELD OF THE INVENTION

The present invention relates generally to the field of lounge chairs. More specifically, the present invention relates to an improved lounge chair with a foldable, reclining frame that supports a cooling bungee weave seating body, a pivotally mounted UV-reflective shade canopy with integrated solar panels, and an onboard battery that powers a fan, a Bluetooth speaker, and a charging station. Accordingly, the present disclosure makes specific reference thereto. Nonetheless, it is to be appreciated that aspects of the present invention are also equally applicable to other like applications, devices, and methods of manufacture.

### BACKGROUND

Outdoor recreation and relaxation often involve prolonged exposure to environmental elements, particularly sunlight and heat, which can negatively affect user comfort and health. Traditional lounge chairs typically provide minimal features, offering basic seating support without integrated amenities that address modern user expectations. Users at beaches, pools, parks, or other outdoor venues frequently lack access to electrical power, making it difficult to charge devices or operate personal cooling systems. Additionally, the absence of built-in shading mechanisms in many seating solutions leaves users vulnerable to direct solar radiation. Individuals may also desire supplementary functionalities such as audio entertainment and ergonomic comfort while engaging in extended periods of rest outdoors. As personal electronic devices have become integral to everyday life, their reliance on consistent power sources creates a disconnect between digital utility and outdoor leisure. Furthermore, the demand for compact, portable furniture solutions that combine structural resilience with multiple utility features remains unmet. These challenges highlight the need for an integrated system capable of enhancing outdoor comfort through advanced functionality and thoughtful design.

Therefore, there exists a long-felt need in the art for a multipurpose lounge chair device that provides integrated solar-powered fans for active cooling. There also exists a long-felt need in the art for a multipurpose lounge chair device that includes onboard charging capabilities to power electronic devices during outdoor use. Moreover, there exists a long-felt need in the art for a multipurpose lounge chair device that offers entertainment and ergonomic comfort through Bluetooth audio and adjustable support features.

The subject matter disclosed and claimed herein, in one embodiment thereof, comprises a multipurpose lounge chair device. The device is comprised of a foldable and reclining frame that supports a seating body fabricated from cooling bungee weave. The device comprises a shade canopy made from UV-reflective fabric, which is pivotally mounted to the frame via adjustable hinges or articulated brackets to maximize solar exposure and shade coverage. At least one flexible monocrystalline solar panel is embedded in the canopy and configured to charge an onboard lithium-based battery. The battery powers at least one fan and at least one Bluetooth speaker, both of which may be controlled by a wired or wireless remote. A swing-out charging station table is attached to the frame by a pivot mechanism and includes multiple charging ports, such as USB or wireless charging pads, along with a non-slip surface for item placement. Armrests, cupholders, adjustable leg supports, and transport straps are also integrated to enhance usability and portability across varied outdoor environments.

In this manner, the multipurpose lounge chair device of the present invention accomplishes all the foregoing objectives and provides an improved lounge chair having solar-powered fans that directly address the issue of outdoor heat exposure, while the charging station ensures that users can maintain power to essential devices even in remote locations. The inclusion of Bluetooth speakers, ergonomic reclining options, and UV-shielding canopies meets the demand for entertainment, comfort, and solar protection during outdoor leisure activities. Together, these features form a lounge chair that resolves long-standing challenges in outdoor seating by delivering practical, self-sustained functionality in a user-oriented design.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose lounge chair device. The device is a portable, multifunctional seating solution designed for outdoor and recreational environments. The device provides ergonomic support, environmental protection, and multiple powered features, including cooling, entertainment, and device charging, targeting scenarios with limited access to traditional power or comfort amenities.

The device is comprised of a frame that includes two supporting legs, which may be telescoping, foldable, spring-loaded, height-adjustable, etc., to accommodate uneven surfaces. The frame is further comprised of at least one pivot point that enables folding and reclining, supporting multiple lockable positions, including a zero gravity recline. A locking fastener secures the frame in a folded configuration and is operable with one hand. An adjustable shoulder strap made from padded or breathable material facilitates transport. At least one armrest is affixed to the frame and may include an integrated or attached cupholder.

A seating body is attached to the frame to enhance ergonomic support and airflow. The body is preferably made of a cooling bungee weave or similar material. A memory foam cushion, enclosed in a removable and washable cover, may be integrated or attachable to the seating body. A shade canopy further shields the user from solar radiation and is comprised of UV-reflective fabric. The canopy includes at least one flexible monocrystalline solar panel mounted to its surface or other areas of the device. The canopy attaches via pivoting attachments that enable multi-axis repositioning and folding.

The device integrates an onboard battery charged by the solar panel. Powered features include at least one fan with adjustable speeds and oscillation, and at least one Bluetooth speaker. These components are controlled using a wired or wireless remote control, which may be rechargeable through the device's charging port. A swing-out charging station table is mounted to the frame via a pivot point and may include a Qi pad, USB-A, USB-C, or 12V DC socket. The table may be textured to prevent item slippage and may include lips or notches for cable routing. The table may also be retractable or detachable.

A method of using the device is also provided, detailing sequential deployment steps including frame and leg extension, recline adjustment, canopy positioning, activation of powered features, and setup of the charging table for device support and power delivery.

Accordingly, the multipurpose lounge chair device of the present invention is particularly advantageous as it provides an improved lounge chair having solar-powered fans that directly address the issue of outdoor heat exposure, while the charging station ensures that users can maintain power to essential devices even in remote locations. The inclusion of Bluetooth speakers, ergonomic reclining options, and UV-shielding canopies meets the demand for entertainment, comfort, and solar protection during outdoor leisure activities. Together, these features form a lounge chair that resolves long-standing challenges in outdoor seating by delivering practical, self-sustained functionality in a user-oriented design, thereby overcoming the limitations of existing lounge chairs known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose lounge chair device of the present invention in the seating position in accordance with the disclosed architecture;

FIG. 2 illustrates a perspective view of one potential embodiment of a multipurpose lounge chair device of the present invention in the reclined position in accordance with the disclosed architecture;

FIG. 3 illustrates a perspective view of one potential embodiment of a multipurpose lounge chair device of the present invention in the folded position in accordance with the disclosed architecture; and

FIG. 4 illustrates a flowchart of a method of using one potential embodiment of a multipurpose lounge chair device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a multipurpose lounge chair device that provides integrated solar-powered fans for active cooling. There also exists a long-felt need in the art for a multipurpose lounge chair device that includes onboard charging capabilities to power electronic devices during outdoor use. Moreover, there exists a long-felt need in the art for a multipurpose lounge chair device that offers entertainment and ergonomic comfort through Bluetooth audio and adjustable support features.

The present invention, in one exemplary embodiment, is comprised of a multipurpose lounge chair device. The invention relates to a multifunctional, portable seating apparatus optimized for outdoor and recreational applications. By incorporating ergonomic support, environmental shielding, and powered features such as cooling, entertainment, and device charging, the apparatus is engineered for use in locations where access to power and comfort amenities is limited or unavailable.

A structural frame forms the base of the apparatus and includes two supporting legs. These legs may be telescoping, foldable, spring-loaded, or height-adjustable to stabilize the apparatus on uneven terrain. At least one pivot point in the frame allows for folding and reclining, supporting multiple lockable positions, including a zero-gravity recline. A locking fastener provides a mechanism for securing the frame in its folded configuration and is designed for single-handed operation. Transport is facilitated by an adjustable shoulder strap fabricated from breathable or padded material. At least one armrest is mounted to the frame and may optionally incorporate an affixed or integrated cupholder.

The seating body is preferably tension-mounted to the frame to improve ergonomic alignment and airflow. A bungee weave or comparable cooling material is used to construct the seating surface. A memory foam cushion, enclosed within a removable and washable cover, may be included as part of or attached to the seating body. A canopy mounted above the seating area provides solar protection and is constructed from UV-reflective fabric. One or more flexible monocrystalline solar panels are integrated into the canopy or other areas of the apparatus. Pivoting attachments secure the canopy to the frame, enabling multi-axis repositioning and compact folding.

An onboard battery receives charge from the integrated solar panel. Electronic features powered by the battery include at least one fan with selectable speed and oscillation settings and at least one Bluetooth speaker. These features are operated via a wired or wireless remote control, which may be rechargeable through an onboard charging port. Additionally, a swing-out charging table is pivotally connected to the frame. This table may support wireless Qi charging, USB-A, USB-C, or 12V DC connections. The surface of the table may be constructed with anti-slip materials and feature cable-routing notches or perimeter lips. The table is designed to be retractable, detachable, or foldable.

A method of use is also disclosed. The procedure involves extending and locking the supporting legs, unfolding the frame to a desired reclined position, positioning the canopy for optimal shading and solar collection, activating the electronic features via remote control, and deploying the charging table to hold personal items and supply electrical power.

As a result, the device offers significant functional advantages, including solar-powered ventilation to mitigate heat exposure and an integrated charging station to maintain device operation in remote environments. Additional features such as Bluetooth audio, ergonomic reclining, and UV protection collectively enhance user comfort and entertainment. These combined capabilities present a practical, self-sustaining solution to challenges inherent in conventional outdoor seating systems.

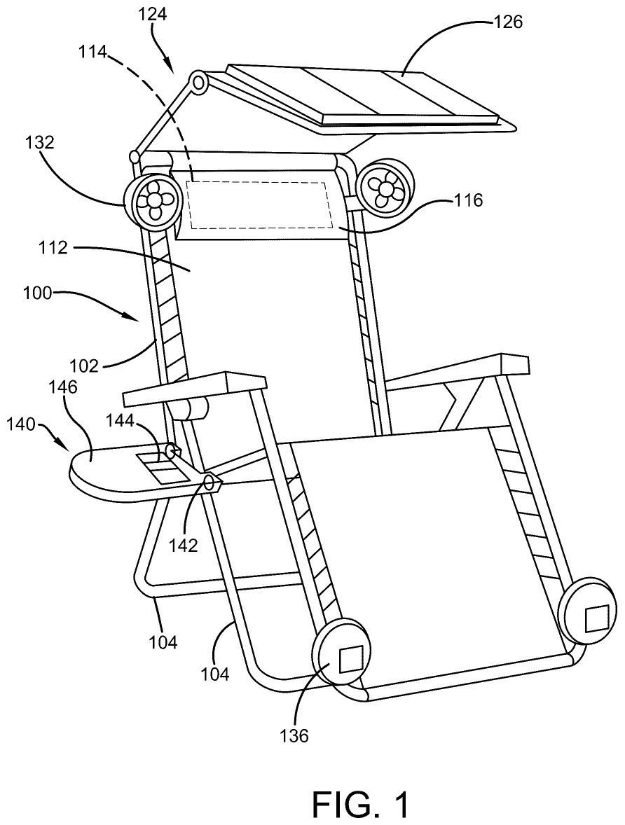

Referring initially to the drawings, FIG. 1 illustrates a perspective view of one potential embodiment of a multipurpose lounge chair device 100 of the present invention in the seating position in accordance with the disclosed architecture. The device 100 is designed to provide a portable and highly adaptable seating solution for outdoor and recreational use. The device 100 integrates structural comfort, environmental protection, and multiple powered features into a single unit, offering users enhanced relaxation through ergonomic support, active cooling, entertainment, and device charging capabilities. The device 100 is intended for deployment in a wide range of outdoor environments, such as, but not limited to, beaches, parks, campsites, outdoor festivals, and sporting events, particularly in scenarios where traditional power access and comfort amenities are unavailable or limited.

The device 100 may be comprised of a frame 102 that may be constructed from materials such as, but not limited to, anodized aircraft-grade aluminum, powder-coated steel, high-strength carbon fiber, or reinforced polymer composites. These materials may be selected to provide a lightweight yet structurally rigid and corrosion-resistant support structure. The frame 102 may include two supporting legs 104 of any style and configuration, such as telescoping, foldable, or spring-loaded styles. In some embodiments, the supporting legs 104 may be height-adjustable legs to accommodate uneven ground surfaces.

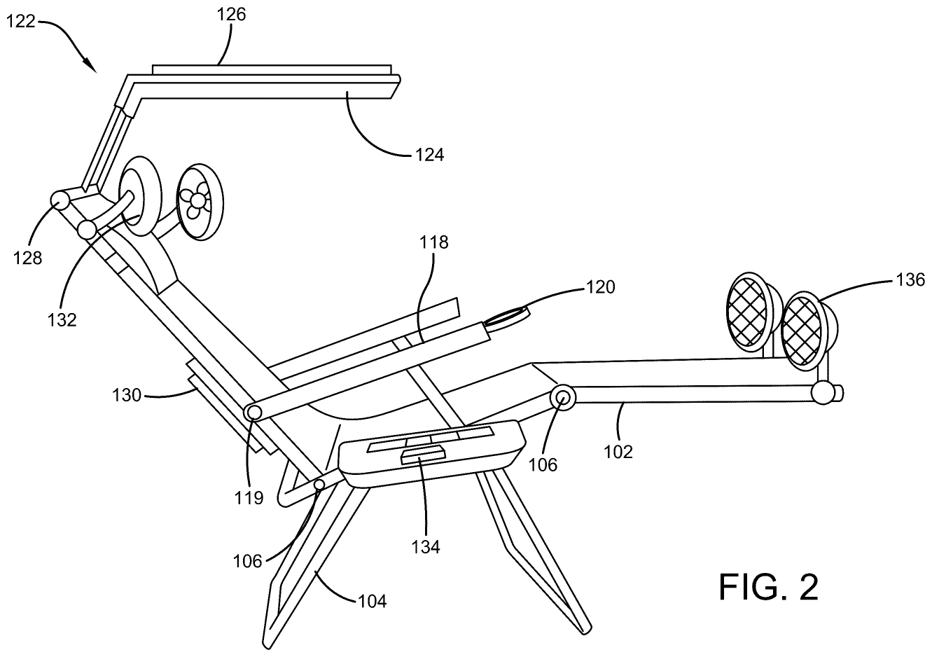

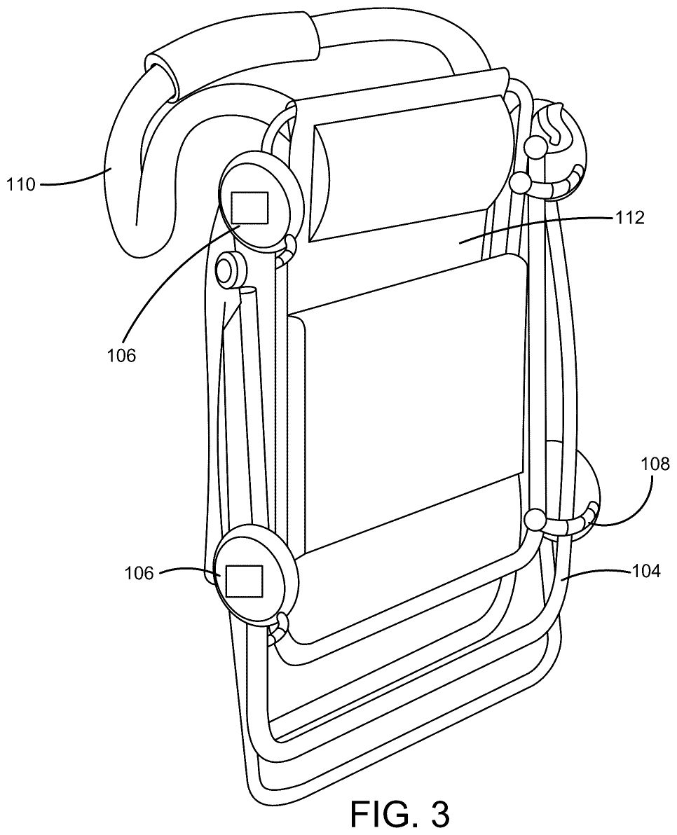

The frame 102 may further include at least one pivot point 106, which may be comprised of high-torque resistant metal pins, polymer bushings, reinforced hinges, etc., enabling reclining and folding functionality of the frame 102. The pivot point 106 may support multiple locked positions ranging from an upright posture to a recline, including a zero gravity recline position, as seen in FIG. 2, that distributes body weight to reduce pressure points. In one embodiment, the frame 102 is comprised of a locking fastener 108, such as, but not limited to, a sliding latch, cam-lock mechanism, or quick-release buckle, which allows the frame 102 to be secured in a folded configuration for transport and storage, as seen in FIG. 3. The locking fastener 108 may be positioned for single-handed operation. In one embodiment, the device 100 is further comprised of an adjustable shoulder strap 110 for transport. The shoulder strap 110 may be made from padded nylon webbing or breathable mesh fabric.

In one embodiment, the frame 102 may be comprised of at least one armrest 118 of any type and style, such as, but not limited to, padded polymer, tubular metal with foam covering, molded composite platforms, etc. At least one cupholder 120 may be integrated into or affixed to the armrest 118, and may be comprised of collapsible mesh, rigid plastic with drainage ports, thermally insulated materials, etc. The armrest 118 attaches to the frame 102 via a pivot point 119, such as, but not limited to, high-torque resistant metal pins, polymer bushings, reinforced hinges, etc.

The device 100 is comprised of a seating body 112 that may be tension-mounted to the frame 102 to optimize ergonomic support. The body 112 is preferably comprised of a cooling bungee cord weave (or other similar cooling fabric material) that may be interlaced through reinforced perimeter grommets or slots. This construction enhances airflow, provides flexible contouring to a wide range of body shapes, and assists in thermal regulation under direct sunlight.

The body 112 may also be comprised of an integrated or removably attached memory foam cushion 114, as seen in FIG. 1 and FIG. 2. The memory foam cushion 114. The memory foam cushion 114 may be enclosed in a removable and washable cover 116 made from materials such as, but not limited to, moisture-wicking polyester, antimicrobial bamboo fiber, or water-resistant nylon.

The device 100 further includes a shade canopy 122 designed to shield the user from solar radiation. The canopy 122 is preferably comprised of a fabric body 124 fabricated from UV-reflective ballistic nylon, although other materials such as solution-dyed acrylic, aluminized polyester, or coated canvas may also be utilized.

At least one flexible monocrystalline solar panel 126 may be embedded on the top surface of the canopy 122 and/or other areas of the device 100, such as the backrest or armrest housings. The solar panel 126 is electrically connected to an onboard battery 130. The canopy 122 may attach to the frame 102 via at least one pivoting attachment 128, such as, but not limited to, a ball joint, locking hinge, articulated arm bracket, etc. The pivoting attachment 128 may allow the canopy 122 to be repositioned across multiple axes for maximum solar exposure and user shade coverage, and also fold for storage/transport.

The device 100 incorporates several electronic features powered by an onboard battery 130 (as seen in FIG. 2), charged by the solar panel 126. The battery 130 may be a lithium-ion or lithium-iron-phosphate (LiFePO4) cell pack. One of the powered features may include at least one fan 132 fixedly or repositionably attached to the frame 102, canopy 122, or other area of the device 100. The fan 132 may be configured with multiple speed settings and oscillation settings. The fan 132 and at least one speaker 136, such as, but not limited to, a Bluetooth speaker, may be controlled via at least one remote control 134. The remote control 134 may be wired or wireless. In one embodiment, the remote control 134 may be rechargeable via the charging port 144 located on the swing-out charging station table 140.

In one embodiment, a swing-out charging station table 140 is mounted to the chair frame 102 via a pivot point 142 such as, but not limited to, a dual-axis hinge, rotating sleeve, or track-mounted bracket, as seen in FIG. 1. The table 140 may include a charging port 144 in the form of a Qi wireless charging pad, USB-A, USB-C, or a 12V DC socket. In one embodiment, a top surface 146 of the table 140 is comprised of a textured rubber, silicone, or elastomeric surface designed to prevent item slippage. The table 140 may be foldable, retractable, or detachable.

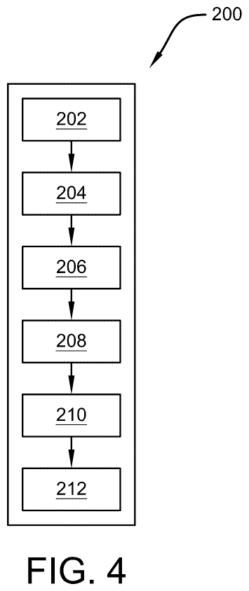

The present invention is also comprised of a method of using 200 the device 100, as seen in FIG. 4. First, a device 100 is provided comprised of a frame 102 comprised of at least two supporting legs 104, at least one pivot point 106, at least one locking fastener 108, at least one adjustable shoulder strap 110, at least one armrest 118 with at least one cupholder 120, a seating body 112 comprised of a memory foam cushion 114 enclosed in a cover 116, a shade canopy 122 with at least one fabric body 124 and at least one flexible monocrystalline solar panel 126, at least one pivoting attachment 128, at least one onboard battery 130, at least one fan 132, at least one remote control 134, at least one Bluetooth speaker 136, and a swing-out charging station table 140 with at least one pivot point 142, at least one charging port 144, and a top surface 146 [Step 202]. Then, the supporting legs 104 can be extended and locked into place to establish a stable base on the ground surface [Step 204]. Next, the frame 102 can be unfolded by actuating the pivot point 106 and secured using the locking fastener 108 to achieve the desired recline position [Step 206]. The shade canopy 122 can then be unfolded and adjusted using the pivoting attachment 128 to optimize sun protection and maximize solar panel 126 exposure for charging the onboard battery 130 [Step 208]. Then, the fan 132 and Bluetooth speaker 136 can be powered and controlled using the remote control 134 to provide airflow and audio entertainment, respectively [Step 210]. Next, the swing-out charging station table 140 can be deployed by rotating it about the pivot point 142 and used to support personal items on the top surface 146 while providing power via the charging port 144 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose lounge chair device” and “device” are interchangeable and refer to the multipurpose lounge chair device 100 of the present invention.

Notwithstanding the foregoing, the multipurpose lounge chair device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multipurpose lounge chair device 100 as shown in the FIGS. are for illustrative purposes only, and that many other sizes and shapes of the multipurpose lounge chair device 100 are well within the scope of the present disclosure. Although the dimensions of the multipurpose lounge chair device 100 are important design parameters for user convenience, the multipurpose lounge chair device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multipurpose lounge chair device comprising:
a frame comprising a leg and a first pivot point;
a seating body attached to the frame;
an armrest attached to the frame via a second pivot point;
a shade canopy attached to the frame;
a solar panel;
a battery electrically connected to the solar panel;
a fan electrically connected to the battery;
a speaker electrically connected to the battery; and
a charging station table mounted to the frame via a third pivot point, the table comprising a charging port.

2. The multipurpose lounge chair device of claim 1, wherein the leg is comprised of a height-adjustable leg.

3. The multipurpose lounge chair device of claim 1, wherein the first pivot point allows the frame to recline.

4. The multipurpose lounge chair device of claim 1 further comprised of a locking fastener.

5. The multipurpose lounge chair device of claim 1 further comprised of a shoulder strap.

6. The multipurpose lounge chair device of claim 1, wherein the seating body is comprised of a cooling bungee cord weave.

7. The multipurpose lounge chair device of claim 1 further comprised of a remote.

8. The multipurpose lounge chair device of claim 7, wherein the remote controls the speaker and the fan.

9. A multipurpose lounge chair device comprising:
a frame comprising a leg and a first pivot point;
a seating body attached to the frame;
a cushion;
an armrest attached to the frame via a second pivot point;
a solar panel;
a battery electrically connected to the solar panel;
a fan electrically connected to the battery;
a speaker electrically connected to the battery;
a charging station table mounted to the frame via a third pivot point, the table comprising a charging port; and
a shade canopy attached to the frame via a fourth pivot point.

10. The multipurpose lounge chair device of claim 9, wherein the shade canopy is comprised of a UV-reflective material.

11. The multipurpose lounge chair device of claim 9, wherein the cushion is comprised of a memory foam cushion.

12. The multipurpose lounge chair device of claim 9, wherein the armrest is comprised of a cupholder.

13. The multipurpose lounge chair device of claim 9, wherein the charging port is comprised of a USB-A port, a USB-C port, or a wireless charging interface.

14. The multipurpose lounge chair device of claim 9, wherein the solar panel is positioned on the shade canopy.

15. The multipurpose lounge chair device of claim 9 further comprised of an adjustable shoulder strap.

16. The multipurpose lounge chair device of claim 9, wherein the fan is comprised of a plurality of speed settings.

17. The multipurpose lounge chair device of claim 9, wherein the fan is comprised of a plurality of oscillation settings.

18. The multipurpose lounge chair device of claim 9, wherein the cushion is comprised of a cover.

19. The multipurpose lounge chair device of claim 18, wherein the cover is comprised of a moisture-wicking material.

20. A method of using a multipurpose lounge chair device, the method comprising the following steps:
providing a multipurpose lounge chair device comprised of providing a portable seating device comprising a frame, a seating body, a shade canopy, a solar panel, a battery electrically connected to the solar panel, a fan electrically connected to the battery, a speaker electrically connected to the battery, and a charging station table mounted to the frame, the charging station table comprising a charging port;
adjusting the frame to achieve a desired seating position;
adjusting the shade canopy to achieve a desired level of sun protection;
powering and operating the fan and the speaker using an electrical energy from the battery; and
using the charging station table to support a personal items and to charge an electronic devices via the charging port.
